(19) United States
(12) Patent Application Publication
(10) Pub. No.: US 2011/0051415 A1
(43) Pub. Date: Mar. 3, 2011

(54) Convective heat-dissipating LED illumination lamp

(76) Inventors: Bishou Chen, Shanghai (CN); Yinghua Wang, Shanghai (CN); Yonghong Qiu, Shanghai (CN); Sheng Li, Shanghai (CN)

(21) Appl. No.: 12/934,995

(22) PCT Filed: Jan. 12, 2009
(86) PCT No.: PCT/CN09/70109

§ 371 Date: Sep. 27, 2010

(30) Foreign Application Priority Data
Dec. 8, 2008 (CN) 20081020412.5

(51) Int. Cl. F21V 5/00; F21S 4/00

(52) U.S. Cl. 362/235; 362/249.01; 362/249.02

(57) ABSTRACT

A convective heat-dissipating light emitting diode (LED) illumination lamp includes a plurality of LED lighting heat-dissipating units (1), a base (2) for installing the LED lighting heat-dissipating units (1), and a frame (4). The base (2) is fixedly connected with the frame (4). The base (2) includes a plurality of strip-shaped members spacedly arranged from each other at a certain distance or the base (2) is a grid-shaped member for forming a hollow-out structure, so that a plurality of channels for direct convection with environmental air are formed in the base (2). The LED lighting heat-dissipating units (1) are spacedly provided on the strip-shaped members and the grid-shaped member. Each of the LED lighting heat-dissipating units (1) includes an LED chip, a circuit board, a circuit connecting member and a corresponding radiator, and forms an independent waterproof sealing body.

### BACKGROUND OF THE PRESENT INVENTION

1. Field of Invention

The present invention relates to an LED illumination lamp, and more particularly to an LED illumination lamp which dissipates heat by the convection mode.

2. Description of Related Arts

The current LED illumination lamp usually uses the integral sealing and the integral heat dissipation technology, that is to say, a plurality of low-power LEDs are directly weldedly fixed on a circuit board at a certain interval, then the circuit board is fixed to a heat-dissipating plate or a whole heat-dissipating casing of a lamp, so that the heat dissipation of the LEDs can be achieved. To prevent moisture and water, a mask made of glass (or other transparent materials) is added to the front of the lamp. As disclosed in China Invention Patent No. 200720050776.X, an LED illumination lamp comprises a protective outer cover and an aluminum substrate, an LED chip is preset on the aluminum substrate.

The above mentioned LED illumination lamp has some shortcomings as follows.

A plurality of low-power LEDs share a radiator, so the heat is too concentrated, a lot of heat are sealed within the mask made of glass (or other transparent materials). Therefore, the effect of heat dissipation is poor, the luminous efficiency and service life of LEDs are affected. Also, the effect of heat dissipation can be improved by increasing the radiator, thereby resulting in the excessive weight and higher cost of the lamp. Simultaneously, this whole structure don't facilitate replacing the LED devices or members, increases the complex degree of the partial production and maintenance of the light source, thereby resulting in low efficiency and high cost.

### SUMMARY OF THE PRESENT INVENTION

An object of the present invention is to provide a convective heat-dissipating LED illumination lamp, which has the good moistureproof and waterproof performance, excellent heat dissipation performance, modular structure, and facilitates assembling, production and site maintenance.

Accordingly, in order to accomplish the above object, the present invention provides a convective heat-dissipating LED illumination lamp, comprising a plurality of LED lighting heat-dissipating units, a base for installing the lighting heat-dissipating units, and a frame fixedly connected with the base, wherein the base comprises a plurality of strip-shaped members spacedly arranged from each other at a certain distance or the base is a grid-shaped member for forming a hollow-out structure, so that a plurality of channels for direct convection with environmental air are formed in the base, the LED lighting heat-dissipating units are spacedly provided on the strip-shaped members or grid-shaped member, wherein each of the LED lighting heat-dissipating units comprises an LED chip, a circuit board, a circuit connecting member and a corresponding radiator, and forms an independent waterproof sealing body.

Furthermore, the circuit connecting member of each of the LED lighting heat-dissipating units comprises a pair of electrode leads leading from a bottom of the corresponding radiator, the electrode leads are provided within a groove provided at a side face of the base opposite to a side face of the base for installing the LED lighting heat-dissipating units, and connected with a power connector.

The electrode leads are provided within the groove and fixedly sealed by colloid.

Furthermore, the groove is strip-shaped.

Also, an accommodating part for placing the LED chip and the circuit board is provided at a side face of the radiator of each of the LED lighting heat-dissipating units.

Furthermore, a lens is provided over the LED chip, and is integrally and water-resistantly sealed with each of the LED lighting heat-dissipating units.

The base is made of metal.

The beneficial effects of the present invention are shown as follows.

Owing to the independent distribution of the circuit board of every lighting unit and the spaced hollow-out arrangement of the base, the present invention forms a penetrating structure, without the protective cover, thus forming effective convective heat-dissipating channels with the environment. Furthermore, every LED lighting heat-dissipating unit is separately sealed for effectively preventing moisture and water. The base comprises a plurality of strip-shaped members, thus facilitating the modular production, assembly production and site maintenance.

Every member of the present invention is separately sealed (every lighting heat-dissipating unit is separately sealed, and the circuit board and the cable are separately sealed). The surface of every lighting heat-dissipating unit can directly contact the environmental air for dissipating heat respectively, in such a manner that the heat dissipation of the whole LED lamp is divided into the separate heat-dissipation of a plurality of LED lighting units, so that the heat-dissipation surfaces are increased in the case of using the same aluminum.

If the structural strength permits, almost infinitely many LED lighting heat-dissipating units can be assembled together to be a great-power LED illumination lamp. Therefore, the present invention provides a much higher power waterproof LED illumination lamp under the circumstance that the upper limit on the power of an LED is greatly limited caused by the limitation of the heat-dissipation technology.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a preferred embodiment of the present invention.

FIG. 2 is a perspective view of a base of the present invention.

FIG. 3 is a three-dimensional diagram of a lighting heat-dissipating unit of the present invention.

FIG. 4 is a sectional view of the above lighting heat-dissipating unit of the present invention.

FIG. 5 is another perspective view of the base of the present invention.

### DETAILED DESCRIPTION OF THE PREFERRED EMBODIMENT

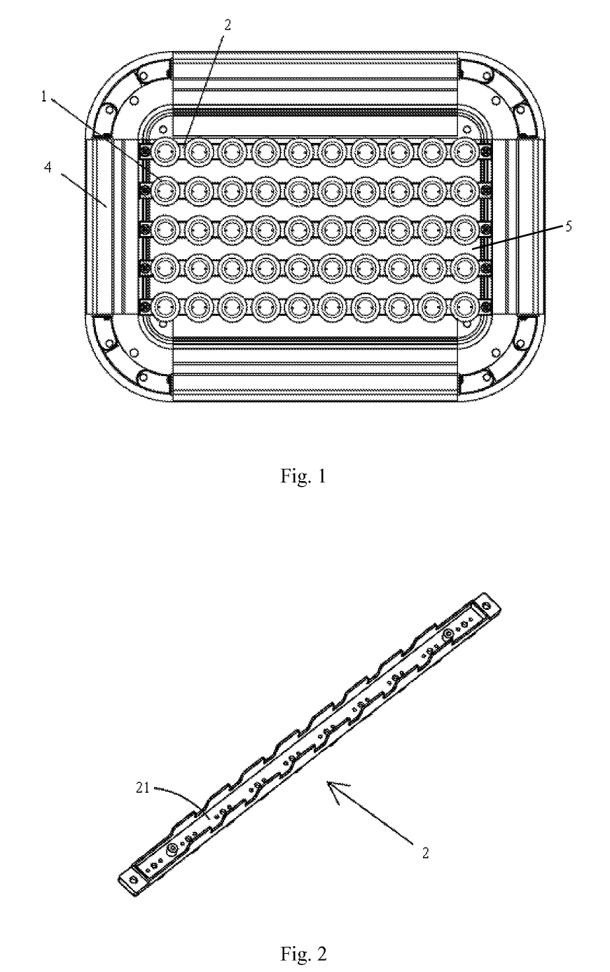

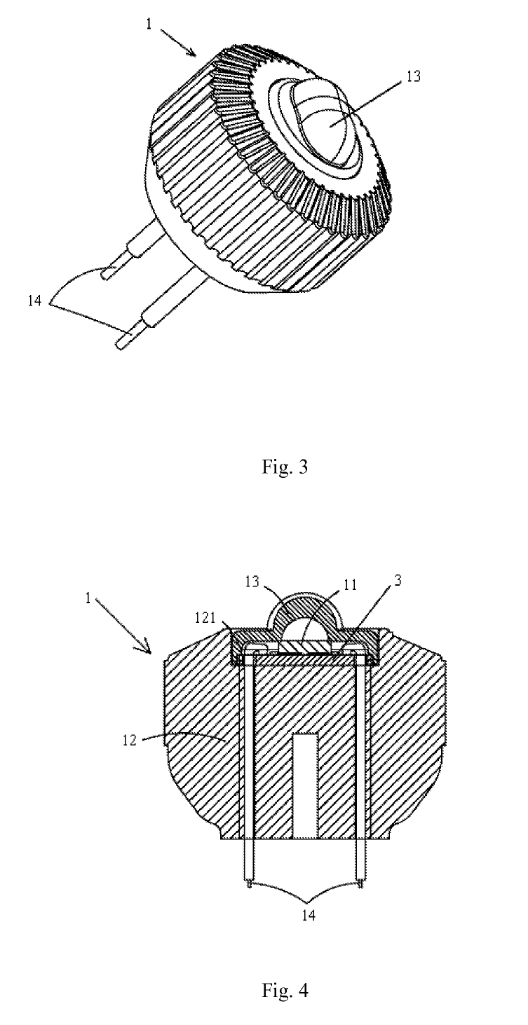

Referring to FIGS. 1 to 4, a convective heat-dissipating LED illumination lamp according to a preferred embodiment of the present invention is illustrated, wherein the convective heat-dissipating LED illumination lamp comprises a plurality of LED lighting heat-dissipating units 1, a base 2 for installing the lighting heat-dissipating units, and a frame 4 fixedly connected with the base 2.

The base 2 comprises a plurality of strip-shaped members spacedly arranged from each other at a certain distance, thus forming a hollow-out structure. Therefore, a plurality of channels for direct convection with environment air are formed in the base 2. The LED lighting heat-dissipating units 1 are spacedly provided on the strip-shaped members. Each of the LED lighting heat-dissipating units 1 can independently contact environment air, thus dissipating heat respectively.

Each of the LED lighting heat-dissipating units 1 comprises an LED chip 11, a circuit board 3, a circuit connecting member 14 (which is positive and negative leads in the preferred embodiment) and a corresponding radiator 12, and forms an independent waterproof sealing body. The circuit board 3 is independently waterproof sealed.

The circuit connecting member 14 of each of the LED lighting heat-dissipating units 1 comprises a pair of electrode leads leading from a bottom of the corresponding radiator 12. The electrode leads are provided within a groove 21 provided at a side face of the base 2 opposite to a side face of the base 2 for installing the LED lighting heat-dissipating units 1, and connected with a power connector 14. The electrode leads are provided within the groove 21 and fixedly sealed by colloid. The groove 21 is strip-shaped.

Furthermore, an accommodating part 121 for placing the LED chip 11 and the circuit board 3 is provided at a side face of the radiator 12 of each of the LED lighting heat-dissipating units 1. A lens 13 is provided over the LED chip 11, and is integrally and water-resistantly sealed with each of the LED lighting heat-dissipating units 1. The lens 13 can not only seal the circuit board 3 by the sealing material, but effectively regulate the light distribution of the LEDs.

The base 2 is made of metal.

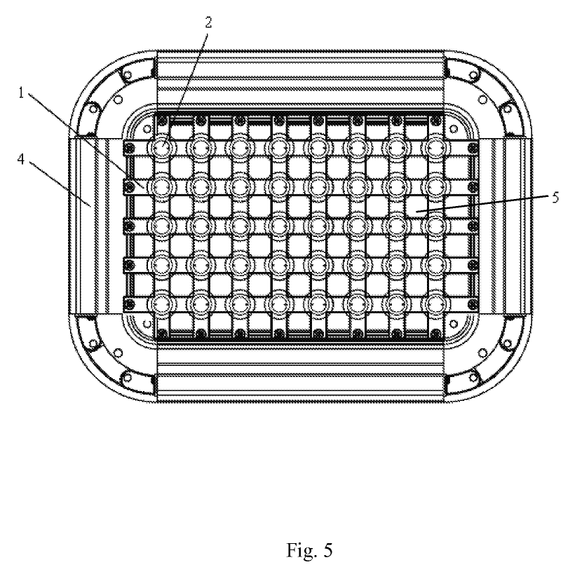

Referring to FIG. 5, the base 2 of the present invention also can be a grid-shaped structure. The LED lighting heat-dissipating units 1 are spacedly provided on the grid-shaped structure.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-8. (canceled)

9. A convective heat-dissipating LED illumination lamp, comprising:
a plurality of LED lighting heat-dissipating units;
a base for installing said LED lighting heat-dissipating units, wherein said base, having a hollow-out structure, comprises a plurality of strip-shaped members spacedly arranged from each other at a certain distance, so that a plurality of channels for direct convection with environment air are formed in said base, wherein said LED lighting heat-dissipating units are spacedly provided on said strip-shaped members; and
a frame fixedly connected with said base.

10. The convective heat-dissipating LED illumination lamp, as recited in claim 9, wherein each of said LED lighting heat-dissipating units comprises an LED chip, a circuit board, a circuit connecting member and a corresponding radiator, and forms an independent waterproof sealing body.

11. The convective heat-dissipating LED illumination lamp, as recited in claim 10, wherein said LED lighting heat-dissipating units, arrayed on said base, form a shape selected from the group consisting of square, round, ellipse, trapezoid, hexagon and quincunx.

12. The convective heat-dissipating LED illumination lamp, as recited in claim 10, wherein said base has a groove provided at a side face thereof opposite to a side face of said base for installing said LED lighting heat-dissipating units, said circuit connecting member comprises a pair of electrode leads leading from a bottom of said radiator, said electrode leads are provided within said groove and connected with a power connector.

13. The convective heat-dissipating LED illumination lamp, as recited in claim 12, wherein said electrode leads are provided within said groove and fixedly sealed by colloid.

14. The convective heat-dissipating LED illumination lamp, as recited in claim 12, wherein said groove is strip-shaped.

15. The convective heat-dissipating LED illumination lamp, as recited in claim 13, wherein said groove is strip-shaped.

16. The convective heat-dissipating LED illumination lamp, as recited in claim 10, wherein an accommodating part for placing said LED chip and said circuit board is provided at a side surface of said radiator of each of said LED lighting heat-dissipating units.

17. The convective heat-dissipating LED illumination lamp, as recited in claim 10, wherein a lens is provided over said LED chip, and is integrally and water-resistantly sealed with each of said LED lighting heat-dissipating units.

18. The convective heat-dissipating LED illumination lamp, as recited in claim 10, wherein said base is made of metal.

19. A convective heat-dissipating LED illumination lamp, comprising:
a plurality of LED lighting heat-dissipating units;
a base for installing said LED lighting heat-dissipating units, wherein said base, having a hollow-out structure, is a grid-shaped member, so that a plurality of channels for direct convection with environment air are formed in said base, wherein said LED lighting heat-dissipating units are spacedly provided on said grid-shaped member; and
a frame fixedly connected with said base.

20. The convective heat-dissipating LED illumination lamp, as recited in claim 19, wherein each of said LED lighting heat-dissipating units comprises an LED chip, a circuit board, a circuit connecting member and a corresponding radiator, and forms an independent waterproof sealing body

21. The convective heat-dissipating LED illumination lamp, as recited in claim 20, wherein said LED lighting heat-dissipating units, arrayed on said base, form a shape selected from the group consisting of square, round, ellipse, trapezoid, hexagon and quincunx.

22. The convective heat-dissipating LED illumination lamp, as recited in claim 20, wherein said base has a groove provided at a side face thereof opposite to a side face of said base for installing said LED lighting heat-dissipating units, said circuit connecting member comprises a pair of electrode leads leading from a bottom of said radiator, said electrode leads are provided within said groove and connected with a power connector.

23. The convective heat-dissipating LED illumination lamp, as recited in claim 22, wherein said electrode leads are provided within said groove and fixedly sealed by colloid.

24. The convective heat-dissipating LED illumination lamp, as recited in claim 22, wherein said groove is strip-shaped.

25. The convective heat-dissipating LED illumination lamp, as recited in claim 23, wherein said groove is strip-shaped.

26. The convective heat-dissipating LED illumination lamp, as recited in claim 20, wherein an accommodating part for placing said LED chip and said circuit board is provided at a side face of said radiator of each of said LED lighting heat-dissipating units.

27. The convective heat-dissipating LED illumination lamp, as recited in claim 20, wherein a lens is provided over said LED chip, and is integrally and water-resistantly sealed with each of said LED lighting heat-dissipating units.

28. The convective heat-dissipating LED illumination lamp, as recited in claim 20, wherein said base is made of metal.
